(19) United States
(12) Patent Application Publication
(10) Pub. No.: US 2006/0208479 A1
(43) Pub. Date: Sep. 21, 2006

(54) Pipe unit with connector and producing method thereof

(75) Inventors: Yuji Ozaka, Okazaki-city (JP); Takao Ikeda, Okazaki-city (JP); Makoto Ito, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/368,067

(22) Filed: Mar. 3, 2006

(30) Foreign Application Priority Data
Mar. 3, 2005 (JP) 2005-059679

(51) Int. Cl. F16L 39/00; B21D 39/00; B21K 1/16

(52) U.S. Cl. 285/124.3; 285/124.1; 29/890.144; 29/890.14; 29/509; 29/523

(57) ABSTRACT

A pipe unit (100) with a connector (120), and a producing method thereof, are disclosed. The pipe unit (100) includes the tabular connector (120) having at least a through hole (121) into which the end portion of a corresponding pipe member (110) is inserted. The end portion of the pipe member (110) is increased in diameter and thereby caulked on the inner surface of the through hole (121). The pipe member (110) includes an enlarged portion (111) with the diameter thereof increased and a non-enlarged portion (112) with the diameter thereof not increased, which are connected to each other by a stepped portion (113) formed outside the connector (120). The thickness of the connector (120) and the machining cost of the through hole (121) are reduced.

### BACKGROUND OF THE INVENTION

1. Field of the Invention

This invention relates to a pipe unit with a connector, and a producing method thereof, suitably used to connect the various component devices of a refrigeration cycle in, for example, an air conditioning system.

2. Description of the Related Art

A conventional pipe unit with a connector is well known as disclosed in Japanese Unexamined Patent Publication No. 2004-108571. In this pipe unit the end of a pipe is inserted into a connector having a through hole larger in diameter than the pipe. In this state, the pipe end is increased in diameter by an enlarging tool and is caulked to the inner surface (through hole) of the connector.

In the conventional pipe unit with a connector, a pipe variation absorbing portion is formed in advance as a relief space for the pipe material in a part of the inner surface of the connector. When the pipe diameter is increased by the enlarging tool, therefore, the extra pipe material is absorbed into the pipe variation absorbing portion, so that the pipe is shortened automatically to a predetermined proper length.

In the conventional pipe unit with a connector, however, the portion between the enlarged portion and the non-enlarged portion is formed as a smoothly tapered stepped portion inside the connector. As a through hole of the connector, therefore, different processes are required to form a hole corresponding to the enlarged portion, a hole corresponding to the non-enlarged portion and a tapered portion corresponding to the stepped portion. As a result, the connector size (thickness) along the pipe length is increased while at the same time increasing the machining cost for the connector.

### SUMMARY OF THE INVENTION

In order to obviate this problem, the object of the present invention is to provide a pipe unit with a connector, and a producing method thereof, wherein the connector thickness and the machining cost of the through hole are reduced.

In order to achieve this object, the invention employs the technical means described below.

According to one aspect of the invention, there is provided a pipe unit (100), with a tabular connector (120) having at least a through hole (121), wherein an end portion of at least a pipe member (110) is inserted in the corresponding through hole (121) and increased in diameter thereby to be caulked on the inner surface of the through hole (121), and wherein the pipe member (110) includes an enlarged portion (111) with the diameter thereof increased, a non-enlarged portion (112) with the diameter thereof not increased and a stepped portion (113) formed on the outside of the connector (120) for connecting the enlarged portion (111) and the non-enlarged portion (112).

As a result, the pipe unit (100) with the connector can be formed simply by forming a straight through hole. (121) corresponding to the enlarged portion (111) in the connector (120), and therefore, the longitudinal size (thickness) of the connector (120) and the machining cost of the through hole (121) are reduced.

According to another aspect of the invention, there is provided a pipe unit with a connector wherein an annular protrusion (114) is formed on the outer periphery of the pipe member (110) and is located on the opposite side of the stepped portion (113) from the connector (120).

In fixing the pipe member (110) with a fixing tool (10) or the like to form the enlarged portion (111), therefore, the protrusion (114) can be used as a stopper for the fixing tool (10) and, therefore, the pipe member (110) can be positively fixed.

According to still another aspect of the invention, there is provided a pipe unit with a connector, wherein the through holes (121) are plural and in which a plurality of pipe members (110) are caulked.

According to yet another aspect of the invention, there is provided a method of producing a pipe unit with a tabular connector by inserting an end portion of at least a pipe member (110) into a corresponding through hole (121) formed in the tabular connector (120) and increasing the diameter of the end portion of the pipe member (110) with an enlarging tool (20) thereby to caulk the end portion on the inner surface of the through hole (121), comprising the steps of fixing the pipe member (110) with a fixing tool (10) adjacent to the connector (120) and forming a stepped portion (113), for connecting an enlarged portion (111) increased in diameter by the enlarging tool (20) with a non-enlarged portion (112) not increased in diameter, inside the fixing tool (10).

Simply by forming the fixing tool (10) with a portion corresponding to the stepped portion (113) and the connector (120) with a straight through hole (121) corresponding to the enlarged portion (111), therefore, the pipe unit (100) with a connector can be produced. As a result, both the length (thickness) of the pipe member (110) inside the connector (120) and the machining cost of the through hole (121) can be reduced.

According to a further aspect of the invention, there is provided a method of producing a pipe unit with a connector, further comprising the steps of forming an annular protrusion (114) in advance on the outer periphery of the pipe member (110), supporting the protrusion (114) with a fixing tool (10), and forming the stepped portion (113) between the connector (120) and the protrusion (114).

The protrusion (114) can be used as a stopper for the fixing tool (10) and, therefore, the pipe member (110) can be positively fixed when forming the enlarged portion (111) and the stepped portion (113).

According to a still further aspect of the invention, there is provided a method of producing a pipe unit (100) with a connector (120) wherein a plurality of through holes (121) are formed and a plurality of the pipe members (110) are caulked simultaneously in the plurality of the through holes (121), respectively.

The reference numerals in parentheses attached to the respective means described above indicate correspondence with a specific means in the embodiments described later.

The present invention may be more fully understood from the description of preferred embodiments of the invention, as set forth below, together with the accompanying drawings.

### BRIEF DESCRIPTION OF THE DRAWINGS

FIG. 1 is a perspective view showing the appearance of a pipe unit with a connector.

FIG. 2 is a sectional view of the pipe unit with a connector shown in FIG. 1.

FIGS. 3A, 3B and 3C are sectional views sequentially showing the steps of the method of producing the pipe unit with a connector.

### DESCRIPTION OF THE PREFERRED EMBODIMENTS

(First Embodiment)

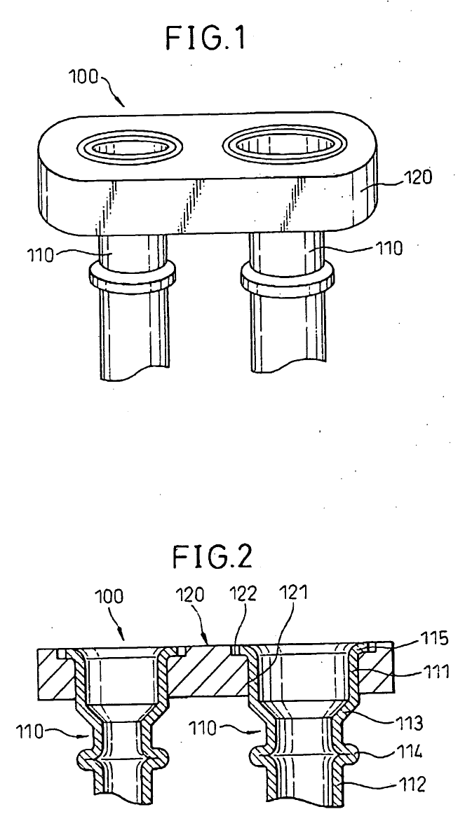

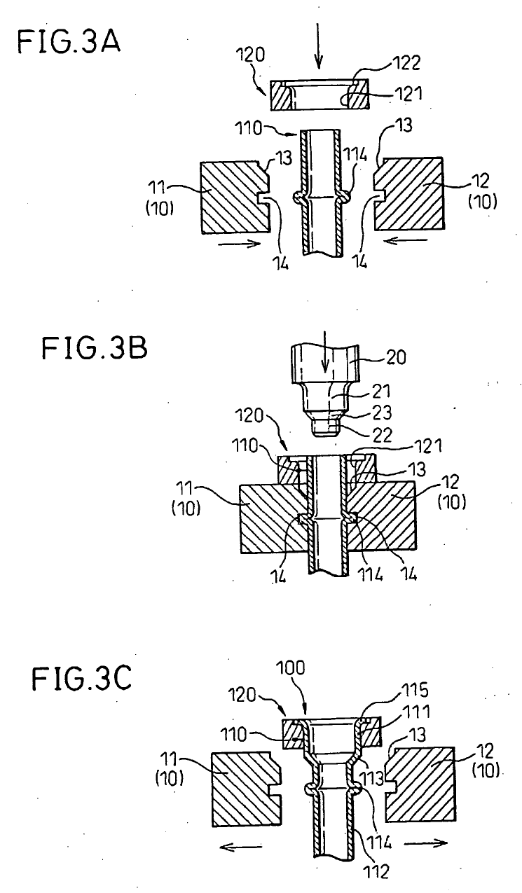

A first embodiment of the invention is explained below with reference to FIGS. 1 to 3. The first embodiment is an azolication of the pipe unit with a connector according to the invention as a pipe unit 100 with a connector to connect the various devices of a refrigeration cycle mounted on a vehicle air conditioning system. FIG. 1 is a perspective view showing the appearance of the pipe unit 100 with a connector, FIG. 2 a sectional view of the pipe unit 100 shown in FIG. 1, and FIGS. 2A to 3C are sectional views showing a method of producing the pipe unit 100 with a connected.

The pipe unit 100 with a connector, as shown in FIGS. 1, 2, comprises pipes 110 as pipe members and a connector 120 as a join. In this embodiment, the pipe unit represents pipes for introducing the refrigerant into and from an evaporator in the refrigeration cycle, and two pipes 110 (one for refrigerant inflow and the other for refrigerant outflow) are connected to one connector 120.

The pipes 110 are made of aluminum or an aluminum alloy formed into long pipes by extrusion and each have a bent portion (not shown) at a predetermined location to meet the requirement for mounting on the vehicle. To secure a predetermined length of the pipes 110 after the bending process, the length is adjusted by partly buckling (bulging) the forward end of the pipes and forming the buckled portions (corresponding to the protrusions in this invention) 114 as annular protrusions on the cuter periphery thereof (For more detail, refer to Japanese Unexamined Patent Publication No. 2004-108571).

The connector 120, like the pipes 110, is formed, of aluminum or an aluminum alloy, into an oval tabular member by extrusion. The connector 120 has through holes 121 formed along the thickness thereof each having an inner diameter larger than the outer diameter of the normal portion (i.e. the non-enlarged portion 112 as compared with the enlarged portion 111) of the pipe 110. Also, by a cutting process and the like, after the extrusion process, one surface of the connector 120 is formed with stepped portions 122 having inner diameters larger than the through holes 121. The connector 120 has stepped portions 122 as large-diameter portions only on one surface thereof. The through holes 121 each have a cylindrical surface and can be formed in the shape of a U or an Ω partly open to the outer peripheral edge of the connector 120.

The forward end portion of each pipe 110 is inserted into the corresponding through hole 121 from the other surface of the connector 120 and increased in diameter by an enlarging punch 20, described later, to thereby form an enlarged portion 111 which is caulked on the inner surface of the through hole 121. A smoothly tapered stepped portion 113 is formed to connect each enlarged portion 111 and the corresponding non-enlarged portion 112 left without being increased in diameter. The stepped portion 113 is formed between the buckled portion 114 and the connector 120 outside the connector 120. The forward end portion 115 of the pipe 110 is bent into the form of a flange along the stepped portion 122 of the connector 120 and thereby strongly caulked on the connector 120 while at the same time absorbing the minor dimensional variations from the buckled portion 114 to the forward end portion 115.

Next, a method of producing the pipe unit 100 with a connector described above is explained with reference to FIGS. 3A to 3C. The pipe unit 100 with a connector, though having two pipes 110 as described above, is shown to include only a single pipe in FIGS. 3A to 3C.

The pipe unit 100 with a connector is produced using a fixing jig 10 and an enlarging punch 20. The fixing jig unit (corresponding to a fixing tool according to the invention) 10 is for fixedly holding the pipe 110 and includes a first fixing jig 11 and a second fixing jig 12 slidable horizontally, in FIGS. 3A to 3C, by a not shown drive unit. The opposed surfaces of the two fixing jigs 11, 12 are each formed with a recess having a semicircular cross section corresponding to the radius of the non-enlarged portion 112 of the pipe 110. The peripheral part of one opening of the hole formed by the recesses when the two fixing jigs 11, 12 are brought into contact with each other constitutes a tapered portion 13 corresponding to the stepped portion 111 of the pipe 110. Also, the intermediate portion of the hole formed by the recesses has a relief portion 14 into which the buckled portion 114 of the pipe 110 can be inserted.

The enlarging punch 20 (corresponding to the enlarging tool according to the invention) which is a jig used to form the enlarged portion 111 and the stepped portion 113 of the pipe 110, is slidable vertically, in FIGS. 3A to 3C, by a not shown drive unit. The forward end portion of the enlarging punch 20 includes an enlarging punch portion 21 to form the enlarged portion 111, a guide portion 22 to secure the slidability in the non-enlarged portion 112 and a tapered punch portion 23 to form the stepped portion 113.

As shown in FIGS. 3A, 3B, the fixing jigs 11, 12 are slid toward the pipe 110 so that the forward end of the pipe 110 comes into a position on the side of the tapered portion 13 of the fixing jigs 11, 12. Thus, the fixing jigs 11, 12 fixedly hold the pipe 110 with the buckled portion 114 fitted in the relief portion 14. After that, the forward end portion of the pipe 110 is inserted into the through hole 121 and set with the connector 120 in contact with the two fixing jigs 11, 12.

Next, as shown in FIG. 3B, the enlarging punch 20 is moved down. Then, the enlarged portion 111 is formed by the enlarging punch portion 21 and caulked on the inner surface of the through hole 121. Also, with the tapered portion 13 supporting the portion between the enlarged portion 111 and the non-enlarged portion 112, the stepped portion 113 is formed in the fixing jigs 11, 12 by the tapered punch portion 23. The forward end portion 115 of the pipe 110 is bent into the form of a flange by the root portion of the enlarging punch portion 21 nearer to the body thereof.

Next, the enlarging punch 20 is moved up and, as shown In FIG. 3C, the fixing jigs 11,. 12 are slid (opened) away from the pipe 110 thereby to retrieve the pipe 110 caulked on the connector 120, i.e. the pipe unit 100 with a connector.

As described above, according to this invention, the stepped portion 113 of the pipe 110 is formed on the outside of the connector 120, i.e. inside the fixing jigs 11, 12. By simply forming a straight through hole 121 corresponding to the enlarged portion 111 on the connector 120, the pipe unit 100 with a connector can be formed. As a result, the length (thickness) of the pipe 110 in the connector 120 can be reduced with a low-cost through hole 121.

The buckled portion 114 is formed on the opposite side of the stepped portion 113 from the connector 120 and inserted into the relief portions 14 of the fixing jigs 11, 12. Therefore, the buckled portion 114 can be used as a stopper of the fixing jigs 11, 12, so that the pipe 110 can be positively fixed when forming the enlarged portion 111 and the stepped portion 113.

(Other Embodiments)

The first Embodiment described above has two pipes 110 arranged on the connector 120. Nevertheless, one pipe or three or more pipes may alternatively be formed with the connector 110.

Also, the buckled portion 114 (with the relief portions 14 of the fixing jigs 11, 12) of the pipe 110 and the flange-like forward end portion 115 (with the stepped portion 122 of the connector 120) may or may not be included, as required.

While the invention has been described by reference to specific embodiments chosen for purposes of illustration, it should be apparent that numerous modifications could be made thereto, by those skilled in the art, without departing from the basic concept and scope of the invention.

1. A pipe unit (100) with a connector (120) comprising:
a tabular connector (120) having at least a through hole (121), and
at least a pipe member (110) being inserted in the corresponding through hole (121) at an end portion thereof, the end portion of the pipe member being increased in diameter thereby to be caulked on the inner surface of the through hole (121),
wherein the pipe member (110) includes an enlarged portion (111) with the diameter thereof increased, a non-enlarged portion (112) with the diameter thereof not increased and a stepped portion (113) for connecting the enlarged portion (111) and the non-enlarged portion (112), the stepped portion being formed on the outside of the connector (120).

2. A pipe unit (100) with a connector (120) according to claim 1,
wherein an annular protrusion (114) is formed on the outer periphery of the pipe member (110) and is located on the opposite side of the stepped portion (113) from the connector (120).

3. A pipe unit (100) with a connector (120) according to claim 1, wherein the through holes (121) are plural and in which a plurality of pipe members (110) are caulked.

4. A pipe unit (100) with a connector (120) according to claim 2, wherein the through holes (121) are plural and in which a plurality of pipe members (110) are caulked.

5. A method of producing a pipe unit (100) with a tabular connector (120) by inserting an end portion of at least a pipe member (110) into a corresponding through hole (121) formed in the tabular connector (120) and increasing the diameter of the end portion of the pipe member (110) with an enlarging tool (20) thereby to caulk the end portion on the inner surface of the through hole (121), comprising the steps of:
fixing the pipe member (110) with a fixing tool (10) adjacent to the connector (120); and
forming a stepped portion (113) for connecting an enlarged portion (111) increased in diameter by the enlarging tool (20) with a non-enlarged portion (112) not increased in diameter, inside the fixing tool (10).

6. A method or producing a pipe unit (100) with a connector (120) according to claim 5, further comprising the steps of:
forming an annular protrusion (114) on the outer periphery of the pipe member (110),
supporting the protrusion (114) with a fixing tool (10); and
forming the stepped portion (113) between the connector (120) and the protrusion (114).

7. A method of producing a pipe unit (100) with a connector (120) according to claim 5, wherein a plurality of through holes (121) are formed and a plurality of the pipe members (110) are caulked simultaneously in the plurality of the through holes (121).

8. A method of producing a pipe unit (100) with a connector (120) according to claim 6, wherein a plurality of through holes (121) are formed and a plurality of the pipe members (110) are caulked simultaneously in the plurality of the through holes (121).
